(19) United States
(12) Patent Application Publication
(10) Pub. No.: US 2025/0100415 A1
(43) Pub. Date: Mar. 27, 2025

(54) CONTROL DEVICE AND CONTROL METHOD

(71) Applicant: TOYOTA JIDOSHA KABUSHIKI KAISHA, Toyota-shi (JP)

(72) Inventor: Keisuke KANAMARU, Nagoya-shi (JP)

(73) Assignee: TOYOTA JIDOSHA KABUSHIKI KAISHA, Toyota-shi (JP)

(21) Appl. No.: 18/732,809

(22) Filed: Jun. 4, 2024

(30) Foreign Application Priority Data
Sep. 26, 2023 (JP) 2023-162858

(51) Int. Cl. B60L 53/66; B60L 53/63; H02J 7/00

(52) U.S. Cl. CPC B60L 53/66; B60L 53/63; H02J 7/00045

(57) ABSTRACT

The charge control ECU (control device) includes a communication unit that communicates with a EVSE (power station) in which external charging (power transfer) is performed with electrified vehicle. When the user desires to respond to the power supply-demand adjustment request, the communication unit notifies electrified vehicle that ISO15118-20 (first standard) is supported by EVSE, and when the user does not desire to respond to the power supply-demand adjustment request, the communication unit notifies EVSE that ISO15118-2 (second standard) is supported by electrified vehicle.

### CROSS-REFERENCE TO RELATED APPLICATION

This application claims priority to Japanese Patent Application No. 2023-162858 filed on Sep. 26, 2023, incorporated herein by reference in its entirety.

### BACKGROUND

### 1. Technical Field

The present disclosure relates to a control device and a control method.

### 2. Description of Related Art

Japanese Unexamined Patent Application Publication No. 2022-139080 (JP 2022-139080 A) discloses a vehicle to be externally charged using first to fifth charging standards and a charging facility. The order of priority is set in advance to the first to fifth charging standards. A connection attempt process is executed sequentially from the charging standard having the highest order of priority.

### SUMMARY

In JP 2022-139080 A, as described above, the order of priority is set in advance to the charging standards. Further, although not described in JP 2022-139080 A, a vehicle can execute charging (hereinafter referred to as Virtual Power Plant (VPP) charging) corresponding to a request for adjusting the power supply-demand state in a power grid and charging (non-VPP charging) not corresponding to the VPP charging. Here, it is assumed that a higher priority is given to a charging standard corresponding to the VPP charging than a charging standard corresponding to the non-VPP charging. In this case, a connection according to the charging standard corresponding to the VPP charging is preferentially attempted, even when a user does not desire the VPP charging, for example. Thus, it is considered that a long time is required to establish a connection according to the charging standard corresponding to the non-VPP charging desired by the user.

The present disclosure has been made in order to address the above issue, and an object of the present disclosure is to provide a control device and a control method capable of quickly establishing a connection according to a standard of power transfer desired by a user between a power station capable of performing power transfer corresponding to a request for adjusting a power supply-demand state in a power grid and an electrified vehicle.

A first aspect of the present disclosure provides a control device that controls power transfer including at least one of charging from a power grid and discharging to the power grid, including:
an acquisition unit that acquires information as to whether a user of an electrified vehicle desires to respond to a request for adjusting a power supply-demand state in the power grid; and
a communication unit that communicates with a power station that executes the power transfer with the electrified vehicle.
   The electrified vehicle supports a first standard that is a standard for the power transfer corresponding to the request and a second standard that is a standard for the power transfer not corresponding to the request.
   The communication unit notifies the power station that the electrified vehicle supports the first standard when the user desires to respond to the request.
   The communication unit notifies the power station that the electrified vehicle supports the second standard when the user does not desire to respond to the request.

In the control device according to the first aspect of the present disclosure, as described above, the power station is notified that the electrified vehicle supports the first standard when the user desires to respond to the request, and the power station is notified that the electrified vehicle supports the second standard when the user does not desire to respond to the request.

Consequently, when a process of connecting the power stand and the electrified vehicle is executed, the power stand can be notified of the standard corresponding to the user's desire to respond to the request. As a result, it is possible to suppress execution of a connection process according to a standard of power transfer that does not correspond to the user's desire. Consequently, it is possible to quickly establish a connection between the electrified vehicle and the power station according to the standard of power transfer corresponding to the user's desire.

In the control device according to the first aspect, preferably,
the communication unit is configured to
notify the power station that the electrified vehicle supports the second standard when information indicating that the power station does not support the first standard after notifying the power station that the electrified vehicle supports the first standard.
   With this configuration, the power stand and the electrified vehicle can be quickly connected according to the second standard, even when the power stand does not support the first standard.

In the control device according to the first aspect, preferably, the communication unit is configured to:
notify the power station that a degree of priority to be used for the power transfer is high in order of the first standard and the second standard when the user desires to respond to the request, and
notify the power station that the degree of priority to be used for the power transfer is high in order of the second standard and the first standard when the user does not desire to respond to the request.
   With this configuration, the order of priority of the standard of power transfer to be indicated to the power station can be changed according to the user's desire for the request.

A second aspect of the present disclosure provides a control method of controlling power transfer including at least one of charging from a power grid and discharging to the power grid, including:
acquiring information as to whether a user of an electrified vehicle desires to respond to a request for adjusting a power supply-demand state in the power grid; and
notifying a power station that executes the power transfer with the electrified vehicle of a standard for the power transfer corresponding to the electrified vehicle.
   The electrified vehicle supports a first standard that is a standard for the power transfer corresponding to the request and a second standard that is a standard for the power transfer not corresponding to the request.
   The notifying includes notifying the power station that the electrified vehicle supports the first standard when the user desires to respond to the request, and notifying the power station that the electrified vehicle supports the second standard when the user does not desire to respond to the request.

In the management method according to the second aspect of the present disclosure, as described above, the power station is notified that the electrified vehicle supports the first standard when the user desires to respond to the request, and the power station is notified that the electrified vehicle supports the second standard when the user does not desire to respond to the request. Consequently, it is possible to provide a control method capable of quickly establishing a connection according to the standard of power transfer desired by the user between the power station and the electrified vehicle.

According to the present disclosure, it is possible to quickly establish a connection according to a standard of power transfer desired by a user between a power station capable of performing power transfer corresponding to a request for adjusting a power supply-demand state in a power grid and an electrified vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to a first embodiment;

FIG. 2 is a sequence diagram illustrating control of the system according to the first embodiment;

FIG. 3 is a diagram illustrating a configuration of a device according to a second embodiment; and

FIG. 4 is a sequence diagram illustrating control of the system according to the second embodiment.

### DETAILED DESCRIPTION OF EMBODIMENTS

Hereinafter, an embodiment of the present disclosure will be described in detail with reference to the drawings. The same or corresponding parts in the drawings are designated by the same reference signs and repetitive description will be omitted.

### First Embodiment

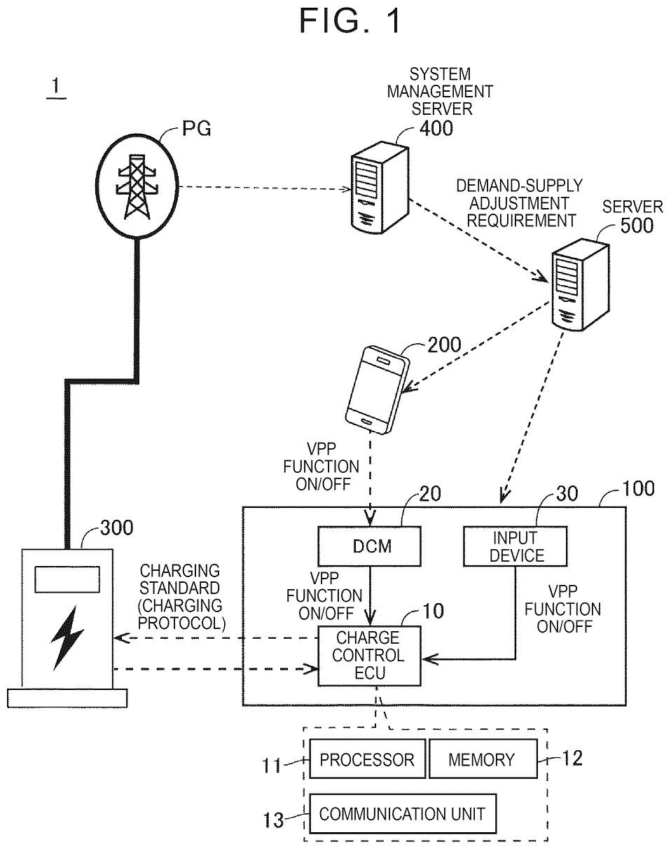

FIG. 1 is a diagram illustrating a configuration of a system 1 according to a first embodiment. The system 1 includes an electrified vehicle 100, a user terminal (e.g., a smart phone) 200, an Electric Vehicle Supply Equipment (EVSE) 300, a system management server 400, a server 500, and an electric power system PG. EVSE 300 and the electric power system PG are exemplary “power stations” and “electric power systems” of the present disclosure, respectively.

The electric power system PG is an electric power system constructed by a power plant and a transmission and distribution facility (not shown). In this embodiment, the electric power company also serves as a power generation company and a power transmission and distribution company. The electric power companies correspond to ordinary transmission and distribution companies, and maintain and manage the electric power system PG. The electric power companies correspond to administrators of the electric power system PG.

The system management server 400 manages power supply and demand in the electric power system PG (power grid). The system management server 400 belongs to an electric power company. The system management server 400 transmits a request (a power supply-demand adjustment request) for adjusting the power supply-demand status in the electric power system PG to the server 500 based on the generated power and the power consumed by the respective power adjustment resources managed by the system management server 400.

The server 500 is a server managed by an aggregator. An aggregator is an electric utility that provides an energy management service by bundling a plurality of power adjustment resources such as a region and a predetermined facility.

The server 500 requests electrified vehicle 100 to perform “external charge” as one unit for adjusting the power demand (power supply and demand status) of the electric power system PG. External charging means charging electrified vehicle 100 using the power of the electric power system PG. The server 500 transmits a request signal for requesting the external charge to the user terminal 200 owned by the user of electrified vehicle 100 or electrified vehicle 100. Note that the external charging is an example of “power transmission” of the present disclosure.

The external charge is performed between electrified vehicle 100 and the electric power system PG via a EVSE 300. Electrified vehicle 100 include, for example, Plug-in Hybrid Electric Vehicle (PHEV), Battery Electric Vehicle (BEV), and Fuel Cell Electric Vehicle (FCEV). The battery (not shown) of electrified vehicle 100 is charged by external charging.

EVSE 300 means a vehicular power supply facility. Electrified vehicle 100 is configured to be electrically connectable to EVSE 300. For example, power can be exchanged between EVSE 300 and electrified vehicle 100 by connecting a charge cable (not shown) of EVSE 300 to an inlet (not shown) of the electrified vehicle 100.

Further, the server 500 is configured to manage information of registered electrified vehicle 100 (hereinafter, also referred to as “vehicle information”), information of registered users (hereinafter, also referred to as “user information”), and information of registered EVSE 300 (hereinafter, also referred to as “EVSE information”). The user information, the vehicle information, and EVSE information are distinguished by the identification information (ID) and stored in a memory (not shown) of the server 500.

Electrified vehicle 100 includes a charge control Electric Control Unit (ECU) 10, a Data Communication Module (DCM) 20, and an inputting device 30 (such as car navigation system). Note that the charge control ECU 10 is an exemplary “control device” of the present disclosure.

The charge control ECU 10 controls external charge between EVSE 300 and electrified vehicle 100. The charge control ECU 10 includes a processor 11, memories 12, and a communication unit 13. The processor 11 is an example of an “acquisition unit” of the present disclosure.

The processor 11 acquires ON/OFF of VPP function. ON/OFF information of VPP function includes information regarding whether or not the user of electrified vehicle 100 desires to respond to a request for adjusting the power supply and demand status in the electric power system PG (hereinafter, referred to as a power supply and demand adjustment request). In the following, the state in which VPP function is ON indicates a state in which the user desires to respond to the power supply-demand adjusting demand. In addition, the state in which VPP function is OFF indicates a state in which the user does not desire to respond to the power supply-demand adjusting demand. The processor 11 acquires ON/OFF of VPP function from at least one of DCM 20 and the inputting device 30.

In the memory 12, information (for example, a map, a mathematical expression, and various parameters) used in the program is stored in addition to the program executed by the processor 11. The communication unit 13 includes various communication I/F. The processor 11 controls the communication unit 13.

The communication unit 13 is configured to be able to communicate with EVSE 300. The communication unit 13 exchanges information of a charging standard (charging protocol) used when external charging is performed with EVSE 300.

In the first embodiment, it is assumed that electrified vehicle 100 corresponds to a charging standard called ISO15118-20 and a charging standard called ISO15118-2. ISO15118-20 is a standard for external charging (hereinafter referred to as VPP charging) corresponding to the demand for adjusting the power supply and demand. ISO15118-2 is a standard for external charging (hereinafter referred to as non VPP charging) that does not correspond to the demand for adjusting the power supply and demand. Note that ISO15118-20 and ISO15118-2 are exemplary “first standard” and “second standard” of the present disclosure, respectively.

Here, in EVSE, for example, it is assumed that the charging standard corresponding to VPP charging is set higher in the precedence order than the charging standard corresponding to non VPP charging in advance. In this case, even when the user does not desire VPP charging, the connection according to the charging standard corresponding to VPP charging is preferentially tried. For this reason, it is considered that it takes a long time to establish a connection according to a charging standard corresponding to a non-charge VPP a user desires.

Therefore, in the first embodiment, the communication unit 13 notifies EVSE 300 that electrified vehicle 100 corresponds to ISO15118-20 when the user desires to respond to the power supply-demand adjusting request (when VPP function is ON). In addition, the communication unit 13 notifies EVSE 300 that electrified vehicle 100 corresponds to ISO15118-2 when the user does not wish to respond to the power supply-demand adjusting request (when VPP function is OFF). Thus, the process of connecting EVSE 300 and electrified vehicle 100 using the charge standard that does not correspond to the user's desire can be suppressed (tried). Consequently, it is possible to suppress a time-loss occurring in the connection between EVSE 300 and electrified vehicle 100.

### Sequence Control in a System

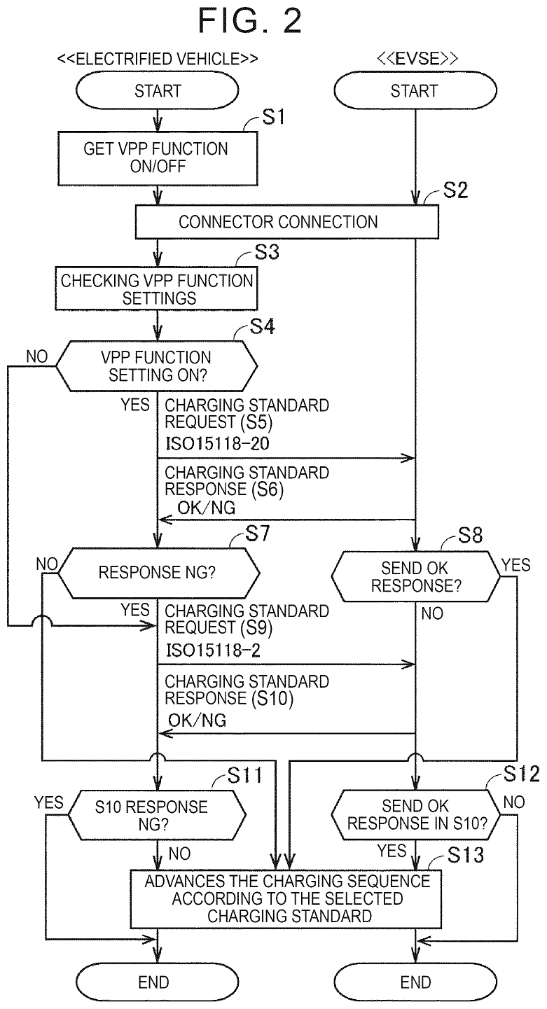

With reference to FIG. 2, the sequence control in the system 1 will be described in detail. The example illustrated in FIG. 2 is merely an example, and the present disclosure is not limited to the example illustrated in FIG. 2. Note that the control of electrified vehicle 100 shown in FIG. 2 is executed by the charge control ECU 10.

In S1, electrified vehicle 100 obtains VPP function ON/OFF. Specifically, the charge control ECU 10 acquires VPP function ON/OFF from DCM 20 or the inputting device 30.

In S2, electrified vehicle 100 and EVSE 300 are connected (connector-connected) by a charge cable (not shown).

In S3, electrified vehicle 100 checks VPP function ON/OFF obtained in S1.

In S4, electrified vehicle 100 determines whether or not VPP function is in ON state (a state in which an external charge corresponding to the power supply-demand adjusting request is desired) in the information acquired in S1. If VPP function is ON (Yes in S4), the process proceeds to S5. When VPP function is in OFF state (a state in which an external charge that does not correspond to the power supply/demand adjusting request is desired) is acquired (No in S4), the process proceeds to S9.

In S5, electrified vehicle 100 requests ISO15118-20 from EVSE 300 as a charge standard to be used through the communication unit 13.

In S6, EVSE 300 sends a response to S5 request to electrified vehicle 100. EVSE 300 sends an OK to accept S5 request if EVSE 300 corresponds to ISO15118-20. EVSE 300 sends a NG to reject S5 request if EVSE 300 does not support ISO15118-20.

In S7, electrified vehicle 100 determines whether the response in S6 is NG. If the response is NG (Yes in S7), the process proceeds to S9. If the response is OK (No in S7), the process proceeds to S13.

In S8, EVSE 300 determines whether or not an OK response has been transmitted in S6. When OK response is transmitted (Yes in S8), the process proceeds to S13. If OK response has not been transmitted (No in S8), the process proceeds to S10.

In S9, electrified vehicle 100 requests ISO15118-2 from EVSE 300 as a charge standard to be used through the communication unit 13.

In S10, EVSE 300 sends a response to S9 request to electrified vehicle 100. EVSE 300 sends an OK to accept S9 request if EVSE 300 corresponds to ISO15118-2. EVSE 300 sends a NG to reject S9 request if EVSE 300 does not support ISO15118-2.

In S11, electrified vehicle 100 determines whether the response in S10 is NG. If the response is NG (Yes in S11), the process ends. If the response is OK (No in S11), the process proceeds to S13.

In S12, EVSE 300 determines whether or not an OK response has been transmitted in S10. When OK response is transmitted (Yes in S12), the process proceeds to S13. When NG response is transmitted (No in S12), the process ends.

In S13, electrified vehicle 100 and EVSE 300 advance the charging sequence according to the selected charging standard. Specifically, if No in S7 (Yes in S8), the charge-sequence is advanced according to ISO15118-20. On the other hand, if No in S11 (Yes in S12), the charge sequence is advanced according to ISO15118-2.

As described above, in the first embodiment, the communication unit 13 of electrified vehicle 100 notifies EVSE 300 that electrified vehicle 100 corresponds to ISO15118-20 when the user desires to respond to the power supply-demand adjusting request. In addition, the communication unit 13 notifies EVSE 300 that electrified vehicle 100 corresponds to ISO15118-2 when the user does not wish to respond to the power supply-demand adjusting request. Accordingly, it is possible to suppress electrified vehicle 100 and EVSE 300 being connected by ISO15118-2 when the user desires to respond to the power supply-demand adjusting demand. As a consequence, the external charge between electrified vehicle 100 and EVSE 300 can be smoothly performed in the format desired by the user.

### Second Embodiment

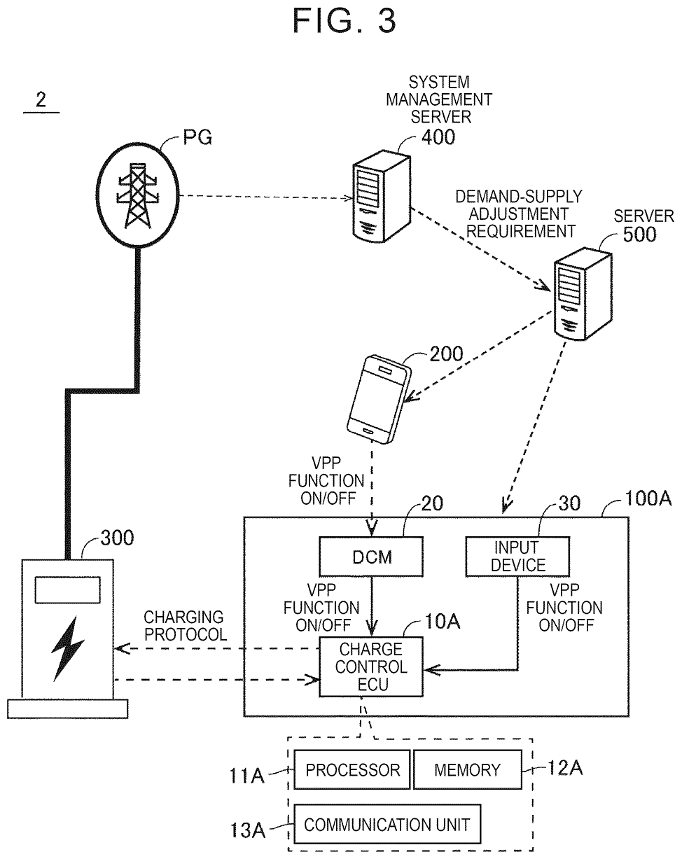

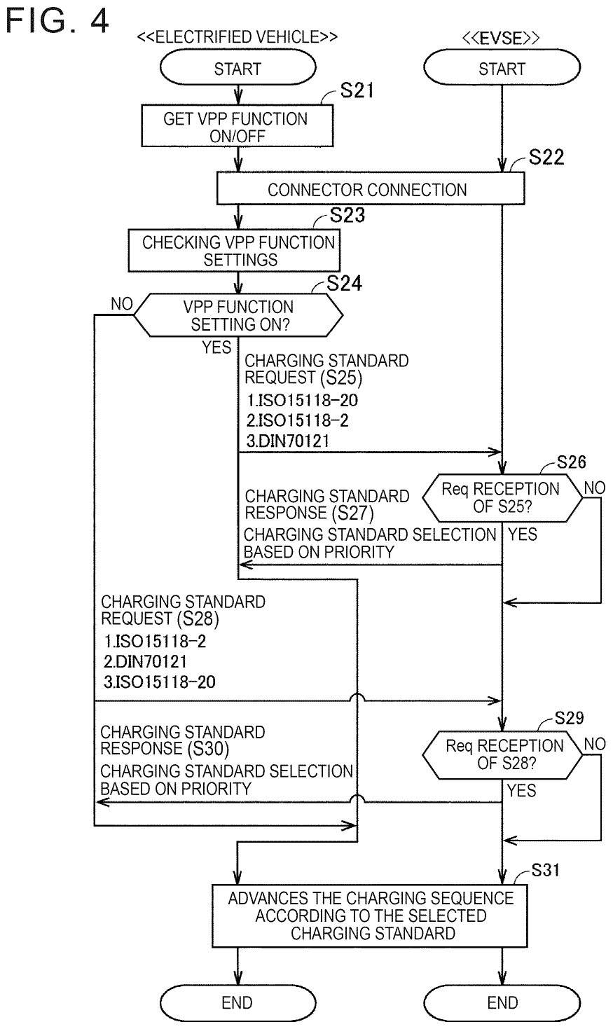

Next, a second embodiment of the present disclosure will be described with reference to FIGS. 3 and 4. In the second embodiment, the priorities of the charge standards are transmitted from electrified vehicle 100A to EVSE 300. The same components as those in the first embodiment are denoted by the same reference numerals and will not be described repeatedly.

FIG. 3 is a diagram illustrating a configuration of the system 2 according to the second embodiment. The system 2 differs from the system 1 of the first embodiment in that it includes an electrified vehicle 100A instead of electrified vehicle 100 of the first embodiment.

Electrified vehicle 100A differs from electrified vehicle 100 of the first embodiment in that a charge control ECU 10A is provided instead of the charge control ECU 10 of the first embodiment. The charge control ECU 10A includes a processor 11A, a memory 12A, and a communication unit 13A. Note that the processor 11A is an exemplary “acquisition unit” of the present disclosure. Further, the charge control ECU 10A is an exemplary “control device” of the present disclosure.

It is assumed that electrified vehicle 100A corresponds to a charging standard called ISO15118-20, a charging standard called ISO15118-2, and a charging standard called DIN70121. DIN70121, like ISO15118-2, is a charging standard that supports non VPP charging. DIN70121 is an exemplary “second standard” of the present disclosure.

### Sequence Control in a System

With reference to FIG. 4, the sequence control in the system 2 will be described in detail. Note that the description of the same processing as in the first embodiment may be simplified in some cases. Note that the control of electrified vehicle 100A shown in FIG. 4 is executed by the charge control ECU 10A.

S21 to S24 are the same processes as S1 to S4 (see FIG. 2) of the first embodiment. If S24 is Yes, the process proceeds to S25. If S24 is No, the process proceeds to S28. EVSE 300 process proceeds to S26 after S22.

In S25, electrified vehicle 100A notifies EVSE 300 through the communication unit 13A that priorities are higher in the order of ISO15118-20, ISO15118-2, DIN70121 as the charge standard to be used. That is, EVSE 300 is notified that the charging standard corresponding to VPP charging has a higher precedence than the charging standard corresponding to the non-VPP charging. In addition, EVSE 300 is notified that ISO15118-2 has higher priorities than DIN70121.

In S26, EVSE 300 determines whether a request in S25 has been received. If a request in S25 has been received (Yes in S26), the process proceeds to S27. If the request in S25 has not been received (No in S26), the process proceeds to S29.

In S27, EVSE 300 selects a charge standard based on priorities in S25 request. Specifically, EVSE 300 selects the charging standard having the highest S25 priorities among the charging standards that can be supported by EVSE 300. For example, a ISO15118-20 is selected if EVSE 300 can correspond to each of ISO15118-20 and ISO15118-2. EVSE 300 notifies electrified vehicle 100A of the selected charge standard.

On the other hand, in S28, electrified vehicle 100A notifies EVSE 300 through the communication unit 13A that priorities are higher in the order of ISO15118-2, DIN70121, ISO15118-20 as the charge standard to be used. That is, EVSE 300 is notified that the charging standard corresponding to the non VPP charging has a higher precedence than the charging standard corresponding to VPP charging. In addition, EVSE 300 is notified that ISO15118-2 has higher priorities than DIN70121.

In S29, electrified vehicle 100A determines whether a request in S28 has been received. If a request in S28 has been received (Yes in S29), the process proceeds to S30. If the request in S28 has not been received (No in S29), the process proceeds to S31.

In S30, EVSE 300 selects a charge standard based on priorities in S28 request. Specifically, EVSE 300 selects the charging standard having the highest S28 priorities among the charging standards that can be supported by EVSE 300. For example, if EVSE 300 can correspond to each of ISO15118-20 and ISO15118-2, a ISO15118-2 is selected. EVSE 300 notifies electrified vehicle 100A of the selected charge standard.

In S31, electrified vehicle 100A and EVSE 300 advance the charging sequence according to the selected charging standard.

Note that the other configurations are the same as those of the first embodiment, and therefore, the description thereof will not be repeated.

In the first embodiment, electrified vehicle 100 corresponds to only ISO15118-20 and ISO15118-2, but the present disclosure is not limited to this. Electrified vehicle 100 of the first embodiment may also correspond to ISO15118-20, ISO15118-2, and DIN70121 as in electrified vehicle 100A of the second embodiment. In this situation, after the response of S10 of FIG. 2 becomes NG, electrified vehicle 100 may request DIN70121 from EVSE 300.

In the first and second embodiments described above, the process when electrified vehicle 100 (100A) performs the external charge is exemplified, but the present disclosure is not limited to this. The same processes as those in the first and second embodiments may be performed at the time of external power supply (external discharging) for supplying power from electrified vehicle 100 (100A) to the electric power system PG. In addition, the above processing may be performed in both the external charging and the external power supply.

In the first and second embodiments described above, the charge control ECU 10 (10A) of electrified vehicle 100 (100A) performs the control of notifying EVSE 300 of the request of the charge standard, but the present disclosure is not limited thereto. A control device (server) provided separately from electrified vehicle may execute the control.

The embodiment disclosed herein should be considered as illustrative and not restrictive in all respects. The scope of the present disclosure is shown by the claims, rather than the above embodiments, and is intended to include all modifications within the meaning and the scope equivalent to those of the claims.

What is claimed is:

1. A control device that controls power transfer including at least one of charging from a power grid and discharging to the power grid, comprising:
an acquisition unit that acquires information as to whether a user of an electrified vehicle desires to respond to a request for adjusting a power supply-demand state in the power grid; and
a communication unit that communicates with a power station that executes the power transfer with the electrified vehicle, wherein:
the electrified vehicle supports a first standard that is a standard for the power transfer corresponding to the request and a second standard that is a standard for the power transfer not corresponding to the request; and
the communication unit is configured to
notify the power station that the electrified vehicle supports the first standard when the user desires to respond to the request, and
notify the power station that the electrified vehicle supports the second standard when the user does not desire to respond to the request.

2. The control device according to claim 1, wherein the communication unit is configured to notify the power station that the electrified vehicle supports the second standard when information indicating that the power station does not support the first standard after notifying the power station that the electrified vehicle supports the first standard.

3. The control device according to claim 1, wherein the communication unit is configured to:
notify the power station that a degree of priority to be used for the power transfer is high in order of the first standard and the second standard when the user desires to respond to the request; and
notify the power station that the degree of priority to be used for the power transfer is high in order of the second standard and the first standard when the user does not desire to respond to the request.

4. A control method of controlling power transfer including at least one of charging from a power grid and discharging to the power grid, comprising:
acquiring information as to whether a user of an electrified vehicle desires to respond to a request for adjusting a power supply-demand state in the power grid; and
notifying a power station that executes the power transfer with the electrified vehicle of a standard for the power transfer corresponding to the electrified vehicle, wherein:
the electrified vehicle supports a first standard that is a standard for the power transfer corresponding to the request and a second standard that is a standard for the power transfer not corresponding to the request; and
the notifying includes notifying the power station that the electrified vehicle supports the first standard when the user desires to respond to the request, and notifying the power station that the electrified vehicle supports the second standard when the user does not desire to respond to the request.
